(19) United States
(12) Patent Application Publication
(10) Pub. No.: US 2006/0176289 A1
(43) Pub. Date: Aug. 10, 2006

(54) Advertisement comprehension in mobile media

(75) Inventor: Stephen Taylor Horn, White Stone, VA (US)

Correspondence Address: Stephen T. Horn, 1661 James Wharf Road, White Stone, VA, 22578, US

(73) Assignee: Summerbrook Media Incorporated

(21) Appl. No.: 11/051,873

(22) Filed: Feb. 5, 2005

(51) Int. Cl. G09G 5/00

(52) U.S. Cl. 345/204

(57) ABSTRACT

The present invention enhances comprehension of advertising messages on GPS computer controlled mobile signs by the implementation of an algorithm that accounts for the relative speed of the viewer, the orientation of the mobile sign relative to the direction of travel, the estimated reading speed of the viewer and the anamorphosic perspective view of a message.

### CROSS-REFERENCE TO RELATED APPLICATIONS

Horn et al applicant of this date titled “Mobile Information Display”

Horn applicant of this date titled “Controlling Customer Demand to Match Capacity”

Horn applicant of this date titled “Sales Method for Mobile Media”

### FEDERALLY SPONSORED RESEARCH

None

### SEQUENCE LISTING

None

### 1. FIELD OF THE INVENTION

The present invention is within the realm of advertising with regard to mobile advertising on GPS enabled, location dependent changeable signs, on trucks or other vehicles where comprehension of the message is important.

### 2. DESCRIPTION OF THE PRIOR ART

Talk about what has been done before.

### 3. SUMMARY OF THE INVENTION

The present invention is used in mobile advertising, particularly advertising that is GPS enabled advertising on the rear of trucks where the message on the LCD sign on the truck changes according to the location and direction of the truck. The present invention includes an algorithm that integrates a number of factors unique to the comprehension of mobile sign text messages. Among these concerns is how to integrate the reading speed of the intended viewer with a changing text message being presented on the front of a truck as the vehicle approaches the viewer in the opposite lane of traffic. Certain factors must be taken into consideration to assure a reasonable amount of comprehension of the message. Factors such as the average length of an advertising slogan along with font size and percentage of text comprehended over a period of time is examined. Further the angle the sign is viewed from effects the perspective of the sign. Sign seen at an acute angle are difficult to read from a passing car and this distortion can be adjusted with a changeable mobile display and changed relative to the speed relative to the observer.

An important factor is that the advertising message is displayed a minimum of 2.1 seconds to allow safe comprehension of the message by a vehicle driver. Among other steps, the method described here works by blocking the computer that operates the update of the LCD display until a minimum of 2.1 seconds has elapsed and only then allowing the up date of the display. Under certain conditions, without a delay mechanism, the LCD display would rapidly change messages back and forth as location changes. These conditions occur where three or more areas of sale can meet such as at a cross roads near a shopping center. Messages could easily change in under a half second making the advertising message both unreadable and annoying without the proposed method. This system effectively blocks scrolling or blinking of changeable signs whether intentional or otherwise. The invention is envisioned as either a mechanism such as a clockwork timer or a chemical timer such as the particular formulation of the liquid crystal in the display or most likely a software code that has a wait function that interrupts the computer update of the message on the display without regard to other demands of the program.

In practice the truck could move between two advertising locations where multiple different messages would be shown on the display from different companies purchasing advertising. Typically such advertising is sold in a cellular geographical format where advertisers purchase a particular area where the ads are to be run at certain times as the truck passes that part of the highway. These are referred to as cell locations or cell areas or just cell or area. Should the display on some such truck have just been updated in one cell or area to show a message and the truck during that brief time move to a location where a new message should be displayed then the present invention delays the loading of the new message on the display for a minimum of 2.1 seconds even though the GPS indicates to the computer that a new message should be displayed. The same quick change could in practice happen if the truck in the same area were to change direction of travel as well. Or in practice should a new updated message be downloaded to the computer with regard to that location, then the presently displayed message could inadvertently be changed by the computer faster than 2.1 seconds desired to aid comprehension and to avoid confusion of the reader. The present aspect of this invention would prevent this.

The reason to strictly delay the update in the display is multifold. The reader or observer of the display is likely to be the driver of an automobile or a passenger in one. The advertising is directed toward people that have other distractions due to the inherent movement of their vehicle relative to the highway and the truck. Safety is only a part reason for the delay. There are many distractions to drivers far exceeding the slow change of text on a sign. Animals along a road side or paper debris being flown in the air are certainly a safety issue but this is not. The issue is the comprehension of the sign and hence the effectiveness of the message on the sign.

For the advertisement to be comprehended, it first must be visually acquired on the truck and recognized as a readable message. Then the message must be read. The average person under less than ideal conditions reads at about one hundred and twenty words per minute with only sixty percent comprehension. The average contemporary slogan is hardly ever more than 4.2 words long. The message must be acquired, read and then internalized before another message is presented. The reading speed of the intended audience and their reading comprehension must be considered as for example children or adults or non native speakers. Such information can be obtained from census records, sampling or direct exposure. The text on a sign, study indicates, is typically re-read more than twice before comprehension occurs but not always. A longer text message requires a longer display time even though the sign has traversed a number of locations that would have called for a new message to be displayed. Almost any slogan that is presented under theses conditions for a shorter time period than 2.1 seconds according to experiments, causes confusion in the observer and requires a relatively substantial recovery time before any message presented to them can be adequately comprehended. Further any subsequent message presented is seriously degraded by the confusion of the reader. The observer under these conditions typically tries to recall the garbled message in order to make sense of the present message being displayed. Most observers of truncated or shortened messages find this irritating and consequently will actively avoid this method of advertising particularly if this problem is persistent. Rather than allowing this advertising resistance to grow, a far more efficient method is to write code into the software or use a mechanism to delay the message update of a mobile sign. Concurrently a software means should be used on signs longer than others to allow complete comprehension where the length or size of the text message determines the delay of the update of the mobile sign. The same message should be further delayed dependent on the speed of the sign as determined by the change in the GPS signal relative to the observer of the sign. This would be of more importance in urban areas where pedestrians are more likely customers or vehicles in the opposing lane than on a highway where a motorist is traveling at the same speed.

The speed of the mobile sign relative to the observer directly effects the time the observer has to comprehend the message. Thus for an observer behind and following a mobile sign, the time to comprehend it is far greater than for an observer approaching a mobile truck sign coming in the opposite direction. The sign in this case being mounted on the front of the truck. A changeable sign on the front must change slower and be simpler to read. Thus while a sign on the back of the truck could read “Turn on your next right for McDonald's”; the sign on the front would be just the word McDonald's and an arrow pointing in the direction of the franchise. The time the observer has to comprehend the message can be determined by the speed of the vehicles on the roadway and the observers orientation to the movement of the mobile sign or the observers direction of travel relative to the direction of travel of the mobile sign.

With regard to traffic coming in the opposite lane toward the mobile sign, the size of the letters on the sign and the length of the message become more critical. If an observer needs 2.1 seconds or more to read a mobile message and the highway speed is 60 mph then the closing speed is 120 mph between the observer and the sign. This is 176 feet per second or 369.6 feet in 2.1 seconds but in actuality the distance is longer because the typical front sign cannot be read when it is perpendicular to the observer. Realistically a truck with the sign on the front must be a minimum of 50 ft in front of the opposing viewer in order to be read or the angle makes the sign unreadable. This increases the distance the sign must be read to 419.6 feet.

The image size of an object is directly proportional to the distance. A twelve inch high letter seen at 420 feet is just as readable as a six inch letter read at 210 feet or a three inch letter is equally visible at 105 feet and so on. It becomes apparent that the speed of the approaching viewer determines both the length of the message because of the size of the font of the message and the minimum viewable time of the message. If the speed of the approaching observer is a combined speed of 120 mph and a twelve inch high letter is used there is just enough time to display one message of 4.2 words on average. In reality the message might have to be displayed longer than the minimum 2.1 seconds required as a minimum for comprehension. Yet if the approaching observer has a combined speed of 60 mph then with a 12 inch high font the advertiser could possibly expect to deliver two messages. The means of determining the speed of the observer could be determined by the type of road or speed limits on a section of roadway or by sequencing two or more GPS positions and computing the speed relative to time. Another method could be with a speedometer means on the vehicle carrying the sign with the presumption that approaching vehicles are traveling at double speed and following vehicle are going the same speed or possibly a little more if one vehicle is a car and the other a truck.

An algorithm for determining the message for a mobile sign that changes could state that: at no time may the sign change faster than 2.1 seconds and signs on the front of a vehicle must have letters eight inches high or higher for closing speeds above 40 mph and at speeds below 40 mph they may have either two messages with letters eight inches high or one message with smaller letters but with a longer display time to effectively deliver any message that could be comprehended. The specifics of such an algorithm can change dependent on numerous variables from weather to the brightness and contrast of the sign but this interrelationship relative to mobile as is versed to stationary non changing signs remains. Such an algorithm must always consider the average reading speed of the intended viewer, as well as the length of the message, as well as the size of the letters, and with particular regard to mobile signs; such an algorithm must further consider the orientation of the sign on the truck and the relative speed of the viewer. This algorithm may be applied automatically by the GPS enabled computer on the truck or by the server sending the message to the truck or by the individual designing the message for the mobile sign.

Further objects and advantages of my invention will become apparent from a consideration of the drawings and or ensuing description.

### 4. BRIEF DESCRIPTION OF THE DRAWINGS

FIG. 1 is a diagram showing the interconnecting flow of information used within the preferred invention.

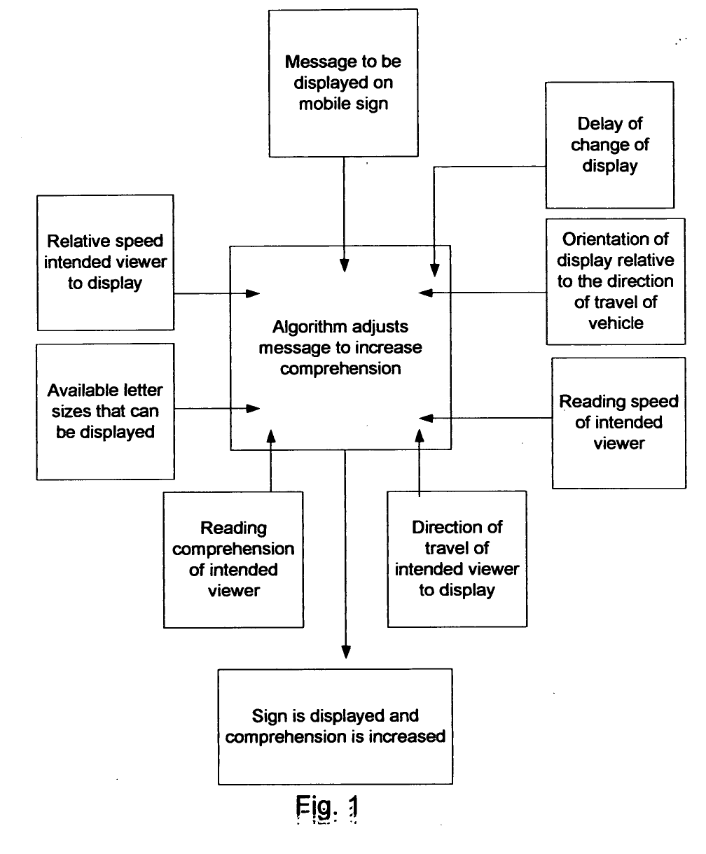

### 5. DETAILED DESCRIPTION OF THE PREFERRED EMBODIMENT

The truck sign should be a minimum of 12 inches high and span the eight feet across the top rear of a tractor trailer but not above the height of the doors on the back. The LCD display should have a pixel diameter at least 0.125 inch in diameter to allow clear letters from a distance. It is immaterial whether an LED or LCD sign is used. The display is operated by a computer which stores a database of advertising slogans and locations where these slogans should be displayed as well as time in flash memory. The orientation of the display is recorded in a database and when the computer calls the server to update messages it identifies itself and thus the orientation of the sign whether front back or side is known and the information is entered into the algorithm. The computer accesses a GPS receiver to determine its current location and then accesses a database of locations to determine which advertisement to should be displayed at any current time. The speed is determined by the known speed of the roadway or by a measurement by the GPS. When the GPS signal matches a designated area in the database, the computer selects the advertisement for the specific time of day from another database. If not done manually or on the home base server, the computer applies an algorithm to the message to be displayed to insure comprehension and adjusts the message font size and time of display accordingly. The computer then sends the message to be displayed on the back of the truck LCD display and a time function starts accessing the clock in the computer. At this time an interrupt prevents further updates of the LCD display until the computer clock measures 2.1 seconds after which the computer is free to change the display on the back of the truck according to any further requirements of the algorithm. If a truck then cross into another area the display will not change for the determined time nor will it change if the computer updates the database advertisement for a particular area. The text or graphic message will remain unaltered on the LCD display for the prescribed time. In this case the LCD display never changes faster than every 2.1 seconds. Should the GPS indicate that the truck is traveling at more than 40 mph in this preferred embodiment then the front sign on the truck would carry 12 inch letters and allow changes accordingly.

The driver side of a truck presents a special problem because passing cars are required to view the sign at an acute angle. This becomes more pronounced at highway speeds where the time to read and comprehend a message is shortened. The present method can account for this with the use of anamorphosic perspective distortion of the text and graphics on the mobile sign. This distortion can be subtle or dramatic narrow roads and fast traffic make it desirable. Anamorphosic perspective is the science of presenting a distorted image that can only be viewed normally when presented at an oblique angle. An example of this is the word stop as it is printed on a road at an intersection. The word stop if viewed from above and looking down on the road would show the letters greatly elongated an proportionally narrow so that they look correct only when viewed from a car as it approaches it. The viewer sees the word at an oblique angle and it looks normal. Such a use could be used on mobile signs to make them more comprehensible if the anamorphosic distortion is done relative to the speed of the observer. A changeable sign can uniquely accomplish this. The distortion would be greatest at highway speeds and the stretching of the letters would not be done when the vehicle is stopped. This is appropriate only to the sides of the vehicles or where the mobile sign is seen at an angle such as mounted high on the back of a truck.

Further definitions are presented here not to be limiting but rather to clarify. The means determining the time an observer has to read a display is directly proportional to the relative speed of the observer to the mobile display. A minimum interval is a minimum time such as 2 seconds. Computing is applying a set of rules to form a result. The orientation of the display is the front back or side of the vehicle. The driver side of the vehicle is the side the driver sits on and the side next to the opposing lane. Thus more traffic is expected to pass the driver side of a truck than the passenger side because the passenger side passes either stopped or parked vehicles or slow vehicles moving in the same direction. A means to determine the orientation of a display is from direct experience or through records kept of each installation of each mobile display. An algorithm is a set of rules that may be applied to data to achieve a unique end. A means to change the size of the text of the display is through software that changes ascii text or a graphic. Comprehension is the amount of information that is understood from a message and is often presented as a percentage. A means of relating various comprehension variables might be to double the size of the font of the text of a display for every doubling of the speed of the observer relative to the mobile sign and any proportion therein. Such doubling to occur until no further letters can fit across the mobile display at which time the message word length would be broken in half and a 2.1 second delay would occur between message changes. Should the message be displayed on the front of the vehicle a further delay of 0.8 seconds would be added to the 2.1 second delay between word portions of the message. Should the message be displayed on the driver side of the vehicle the message display change should be increased by 1.1 seconds and the message be presented in anamorphosic perspective relative to on coming traffic. Thus a means is established to relate the size of text, with the time necessary to read the message, and with the orientation of the sign relative to the traffic and the size of the mobile display. Further considerations could be the reading speed of the intended observer where the delay is proportionally increased to the observers comprehension.

Further objects and advantages of my invention will become apparent from a consideration of the drawings and or ensuing description. There are a number of issues in this invention that are interrelated with one another. Some of this has been discussed but should be restated. There is the issue of direction of travel of both the display with the message on it relative to both a business and other vehicles. The content of the message is determined not only by its location but also by the direction of its travel whether toward a particular exit or business or away. The content of a message is determined by the local time of day whether it might be breakfast time or late at night. The content of a message is determined by the demand cycle of a product. This refers to a product or service that has a particular time span before it is needed again. An example is a hamburger can be desired every few hours but mostly at lunch while a new car is desired every few years or a soft drink could be desired every hour and an oil change every few months. The present invention is distinctly able to accommodate combinations of product demand cycles in conjunction with direction and time. The time a message is exhibited on a display and text size and length is dependent on the above and the relative speed of an observer. All of these considerations must be formed around anticipated potential customers that are determined by their location and direction of travel at a particular time of day. A customer traveling in the direction of a scheduled rock concert at a particular time of day is an anticipated potential customer while the same person at a different time of day or traveling in a different direction or location is not. The anticipated location of a message on a plurality of mobile display units must account for this as well as all the above. Only some of the LCD displays on some of the trucks in this example would be selected to carry a message and these units would direct traffic according to the multiple algorithms suggested above. The present invention is multifaceted and should not be limited without consideration of these factors.

I claim:

1.) A method to increase comprehension of a mobile message display, said method comprising:
a) a means to delay the change of a display,
b) a means to determine the time an observer has to read said display
c) computing minimum interval to delay said display change
d) delaying said display change a minimum interval thus increasing comprehension of a mobile message display.

2.) The method of claim 1 said claim further comprising: a means to change the size of the text of a display

3.) The method of claim 1 said claim further comprising: a means to determine the orientation of the display.

4.) The method of claim 1 wherein the minimum interval time the said message is displayed is 2.1 seconds or greater.

5.) The method of claim 1 said claim further comprising: displaying said mobile message where said display is mounted on the side of the vehicle in anamorphosic perspective.

5.) The method of claim 1 said claim further comprising: a means to relate said delay in change of said display, with said time observer has to read said display, with said observer's reading comprehension, with orientation of said display, with size of text of said display.

6.) A method to increase comprehension of a mobile message display, said method comprising an algorithm

7.) The method of claim 5 said claim further comprising: where a minimum time the said message is displayed is 2.1 seconds or greater.

8.) The method of claim 5 said claim further comprising: a means to determine the orientation of the display.

9.) The method of claim 5 said claim further comprising: a means to change the size of the text of a display.

10.) A method to increase comprehension of a mobile message display, said method comprising:
a) delaying change in said message change to greater than 2.1 seconds
b) requiring a letter size on said display to be eight inches or higher on front mounted displays moving in excess of 40 miles per hour on dual lane highways,
c) requiring side mounted displays to use letters six inches or higher at speeds over 20 miles per hour on dual lane highways
d) delaying said message change on rear mounted displays in a proportion to one second per nine words where such delay is in addition to the said delay of 2.1 seconds and where the nine words are in addition to 4.2 initial words said method thus increasing comprehension of a mobile message display.
